(19) United States
(12) Patent Application Publication
(10) Pub. No.: US 2023/0018096 A1
(43) Pub. Date: Jan. 19, 2023

(54) ANALYSIS APPARATUS, ANALYSIS METHOD, AND NON-TRANSITORY COMPUTER READABLE MEDIUM STORING ANALYSIS PROGRAM

(71) Applicant: NEC Corporation, Minato-ku, Tokyo (JP)

(72) Inventors: Hirofumi UEDA, Tokyo (JP); Ryo MIZUSHIMA, Tokyo (JP); Tomohiko YAGYU, Tokyo (JP)

(73) Assignee: NEC Corporation, Minato-ku, Tokyo (JP)

(21) Appl. No.: 17/786,191

(22) PCT Filed: Dec. 25, 2019
(86) PCT No.: PCT/JP2019/050821

§ 371 Date: Jun. 16, 2022

(51) Int. Cl. H04L 9/40

(52) U.S. Cl. CPC H04L 63/1433; H04L 63/1416; H04L 63/145

(57) ABSTRACT

An analysis apparatus (10) includes an environment assessment unit (11) for assessing environmental metrics of a Common Vulnerability Scoring System (CVSS) as regards a vulnerability in an information system based on an attack path extracted from the information system to which the vulnerability to be analyzed is applied, a base assessment unit (12) for assessing base metrics of the CVSS as regards the vulnerability in the information system based on obtained CVSS base value information of the vulnerability and a predetermined base value countermeasure determination condition of the information system, and a determination unit (13) for determining whether or not the vulnerability in the information system needs to be addressed based on an assessment result of the environmental metrics and an assessment result of the base metrics.

### TECHNICAL FIELD

The present disclosure relates to an analysis apparatus, an analysis method, and a non-transitory computer readable medium storing an analysis program.

### BACKGROUND ART

In recent years, there has been a significant increase in cyberattacks that attack vulnerabilities in information systems, which increases threat to cybersecurity. Therefore, as information systems including control systems and Internet of Things (IoT) become increasingly diverse and complex, appropriate assessment and a countermeasure against vulnerabilities have become a major issue.

CVSS (Common Vulnerability Scoring System) is used for vulnerability assessment. As a related technique, for example, Patent Literature 1 and 2 are known. Patent Literature 1 discloses that a vulnerability analysis apparatus obtains a base value of CVSS as a degree of impact of a vulnerability and displays a screen according to the obtained base value. Patent Literature 2 discloses that an attack graph of an information system is generated and then an impact of an attack is assessed.

### CITATION LIST

### Patent Literature

Patent Literature 1: Japanese Unexamined Patent Application Publication No. 2014-130502
Patent Literature 2: Published Japanese Translation of PCT International Publication for Patent Application, No. 2013-525927

### SUMMARY OF INVENTION

### Technical Problem

However, there is a problem that it is difficult to determine whether or not a vulnerability needs to be addressed although the related techniques such as Patent Literature 1 and 2 utilize the base value of CVSS and the attack graph.

An object of the present disclosure is to provide an analysis apparatus, an analysis method, and a non-transitory computer readable medium storing an analysis program capable of determining whether or not a vulnerability needs to be addressed.

### Solution to Problem

An analysis apparatus according to the present disclosure includes: environment assessment means for assessing environmental metrics of a Common Vulnerability Scoring System (CVSS) as regards a vulnerability in an information system based on an attack path extracted from the information system to which the vulnerability to be analyzed is applied; base assessment means for assessing base metrics of the CVSS as regards the vulnerability in the information system based on obtained CVSS base value information of the vulnerability and a predetermined base value countermeasure determination condition of the information system; and determination means for determining whether or not the vulnerability in the information system needs to be addressed based on an assessment result of the environmental metrics and an assessment result of the base metrics.

An analysis method according to the present disclosure includes:

assessing environmental metrics of a CVSS as regards a vulnerability in an information system based on an attack path extracted from the information system to which the vulnerability to be analyzed is applied; assessing base metrics of the CVSS as regards the vulnerability in the information system based on obtained CVSS base value information of the vulnerability and a predetermined base value countermeasure determination condition of the information system; and
determining whether or not the vulnerability in the information system needs to be addressed based on an assessment result of the environmental metrics and an assessment result of the base metrics.

A non-transitory computer readable medium according to the present disclosure storing an analysis program for causing a computer to execute processing of: assessing environmental metrics of a CVSS as regards a vulnerability in an information system based on an attack path extracted from the information system to which the vulnerability to be analyzed is applied; assessing base metrics of the CVSS as regards the vulnerability in the information system based on obtained CVSS base value information of the vulnerability and a predetermined base value countermeasure determination condition of the information system; and determining whether or not the vulnerability in the information system needs to be addressed based on an assessment result of the environmental metrics and an assessment result of the base metrics.

### Advantageous Effects of Invention

According to the present disclosure, it is possible to provide an analysis apparatus, an analysis method, and a non-transitory computer readable medium storing an analysis program capable of determining whether or not a vulnerability needs to be addressed.

### BRIEF DESCRIPTION OF DRAWINGS

FIG. 1 is a flowchart showing a related vulnerability management method;

FIG. 2 is a configuration diagram showing an outline of an analysis apparatus according to example embodiments;

FIG. 3 is a configuration diagram showing an outline of the analysis apparatus according to the example embodiments;

FIG. 4 is a configuration diagram showing an outline of the analysis apparatus according to the example embodiments;

FIG. 5 is a configuration diagram showing a configuration example of an analysis system according to a first example embodiment;

FIG. 6 is a configuration diagram showing a configuration example of a temporal value determination unit according to the first example embodiment;

FIG. 7 shows an example of a countermeasure determination table according to the first example embodiment;

FIG. 8 is a configuration diagram showing a configuration example of an environmental value determination unit according to the first example embodiment;

FIG. 9 is a configuration diagram showing a configuration example of a base value determination unit according to the first example embodiment;

FIG. 10 shows an example of a policy determination table according to the first example embodiment;

FIG. 11 shows an example of a policy determination table according to the first example embodiment;

FIG. 12 is a flowchart showing an operation example of an analysis system according to the first example embodiment;

FIG. 13 is a flowchart showing vulnerability information collection processing according to the first example embodiment;

FIG. 14 is a flowchart showing temporal value determination processing according to the first example embodiment;

FIG. 15 is a flowchart showing environmental value determination processing according to the first example embodiment;

FIG. 16 is a flowchart showing base value determination processing according to the first example embodiment;

FIG. 17 is a flowchart showing determination result output processing according to the first example embodiment;

FIG. 18 shows a configuration example of an information system analyzed by the analysis system according to the first example embodiment;

FIG. 19 shows an example of analysis elements of an attack path according to the first example embodiment;

FIG. 20 is a diagram for explaining environmental value determination processing according to the first example embodiment;

FIG. 21 is a diagram for explaining the environmental value determination processing according to the first example embodiment;

FIG. 22 shows an example of base value information according to the first example embodiment;

FIG. 23 shows an example of intelligence information according to the first example embodiment;

FIG. 24 shows an output example of a determination result according to the first example embodiment;

FIG. 25 shows an output example of a determination result according to the first example embodiment;

FIG. 26 shows an output example of a determination result according to the first example embodiment; and

FIG. 27 is a configuration diagram showing an outline of hardware of a computer according to the example embodiments.

### DESCRIPTION OF EMBODIMENTS

Example embodiments will be described below with reference to the drawings. In each of the drawings, the same elements are denoted by the same reference signs, and repeated explanations are omitted if necessary.

### Study Leading to Example Embodiments

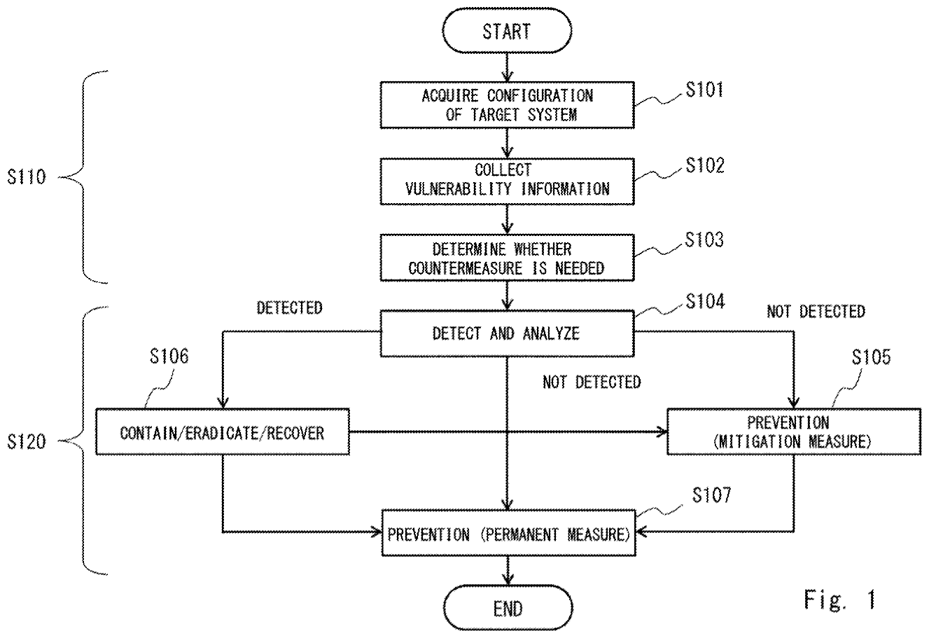

First, management of vulnerabilities in information systems are investigated. FIG. 1 shows a related vulnerability management method. This method is mainly performed by an administrator.

As shown in FIG. 1, in the related vulnerability management method, a vulnerability of a target information system is first recognized (S110), and the recognized vulnerability is addressed (S120).

In the recognition of the vulnerability (S110), a configuration of the information system is acquired (S101). Software and hardware included in the information system are acquired by referring to a detailed design document of the information system and obtaining system configuration information of the information system.

Next, vulnerability information of the information system is collected (S102). The vulnerability information of the acquired software and hardware is collected from alert information by IPA (Information-technology Promotion Agency), public databases of vulnerability information such as CVE (Common Vulnerabilities and Exposures) and NVD (National Vulnerability Database).

Next, it is determined whether or not the vulnerability needs to be addressed (S103). Based on the collected vulnerability information, it is determined whether or not the vulnerabilities of the software and the hardware should be addressed in the information system.

When it is determined that a countermeasure is needed, detection and analysis (S104) of an attack exploiting the vulnerability are performed as a countermeasure against the vulnerability (S120). By referring to a log of the information system, it is confirmed whether there is any trace of the attack which exploited the corresponding vulnerability. Depending on a result of the detection of the attack exploiting the vulnerability and the details of the vulnerability, necessary countermeasures such as prevention (mitigation measure) (S105), containment/eradication/recovery (S106), and prevention (permanent measure) (S107) shall be taken. In the prevention (mitigation measure) (S105), filtering of IP (Internet Protocol) addresses and URLs (Uniform Resource Locators) is set in the information system. The containment/eradication/recovery (S106) involve incident handling. In the prevention (permanent measure) (S107), a patch is installed in the information system.

With such a management method, for example, when a new vulnerability is discovered, an impact on the information system is assessed, and the administrator determines whether or not the vulnerability needs to be addressed. Safety of information systems can be maintained by addressing newly discovered vulnerabilities.

However, there is a problem that it is difficult to determine whether or not vulnerabilities need to be addressed. In other words, although CVSS has been proposed as a method for assessing vulnerabilities, it is difficult to appropriately determine each assessment value of CVSS.

Specifically, in CVSS, vulnerabilities are assessed according to base metrics, temporal metrics, and environmental metrics. The base metrics are used to assess the characteristics of vulnerabilities themselves, and base values (base scores) are calculated in view of impact on confidentiality, integrity, availability and so on. The base value is fixed, and the vulnerability information is disclosed by public databases, vendors or the like.

The temporal metrics are used to assess the current severity of vulnerabilities, and temporal values (temporal scores) are calculated in view of the possibility of being attacked (exploitability) and the availability of a measure (remediation). The temporal value varies depending on the situation and is disclosed by public databases of vulnerability information and vendors or the like.

The environmental metrics are used to assess the severity of the final vulnerability, including the user environment of the product. The environmental values (environmental scores) are calculated in view of the possibility of secondary damage (collateral damage potential) and an affected range of the system (target distribution). The environmental values are calculated by product users, because they vary for each product user.

In CVSS, it is necessary to determine whether or not the vulnerability needs to be addressed according to these three metrics. However, since CVSS is quantified by numerical values of the base value, the temporal value, and the environmental value, it is difficult to determine whether or not a vulnerability needs to be addressed, because the risk is not specific. For example, an expert may make a comprehensive determination each time without using CVSS. In practice, due to the complexity of the calculation, etc., the determination is often made based on only the base value without using the temporal value and the environmental value. However, it is not possible to properly assess the vulnerability based on only the base value, because the situation deviates from the current one.

Therefore, in the following example embodiments, it is possible to automatically determine whether or not a vulnerability needs to be addressed according to the information system.

### Outline of Example Embodiments

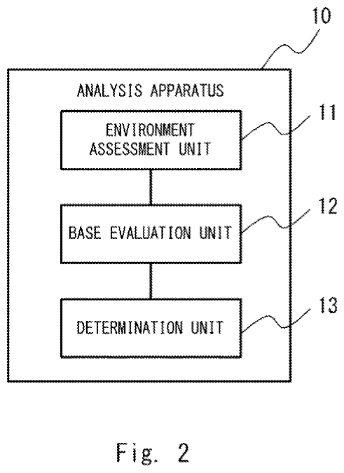

FIG. 2 shows an outline of an analysis apparatus according to the example embodiments. As shown in FIG. 2, an analysis apparatus 10 according to the example embodiments includes an environment assessment unit 11, a base assessment unit 12, and a determination unit 13.

The environment assessment unit 11 assesses the environmental metrics of CVSS as regards the vulnerability in the information system based on an attack path extracted from the information system to which the vulnerability to be analyzed is applied by using an attack graph generation technique or the like. The base assessment unit 12 assesses the base metrics of the CVSS as regards the vulnerability in the information system based on obtained CVSS base value information of the vulnerability and a predetermined base value countermeasure determination condition (base value countermeasure policy) of the information system. The determination unit 13 determines whether or not the vulnerability in the information system needs to be addressed based on the assessment result of the environmental metrics obtained by the environment assessment unit 11 and the assessment result of the base metrics obtained by the base assessment unit 12.

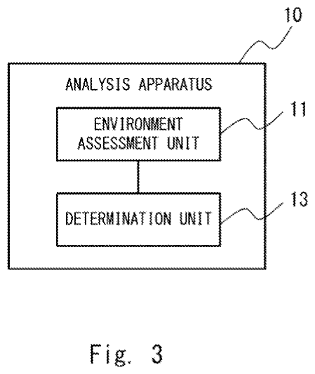

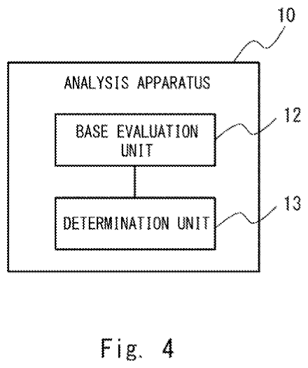

The analysis apparatus 10 may have at least the configuration shown in FIG. 3 or FIG. 4. For example, as shown in FIG. 3, the analysis apparatus 10 may include the environment assessment unit 11 and the determination unit 13. The determination unit 13 may determine whether or not the vulnerability of the information system needs to be addressed based on the assessment result obtained by the environment assessment unit 11. As shown in FIG. 4, the analysis apparatus 10 may include the base assessment unit 12 and the determination unit 13. The determination unit 13 may determine whether or not the vulnerability of the information system needs to be addressed based on the assessment result of the base metrics obtained by the base assessment unit 12. Further, the analysis apparatus 10 may include a temporal assessment unit for assessing the temporal metrics of the CVSS as regards the vulnerability in the information system based on the obtained CVSS temporal value information and a predetermined temporal value countermeasure determination condition (countermeasure determination table) of the information system.

In this way, an attack path is extracted from the information system to which the vulnerability has been applied by using an attack graph generation technique or the like, and the environmental metrics in the information system can be appropriately assessed based on the extracted attack path. Further, for example, the CVSS base value information of a publicly disclosed vulnerability is acquired and the base metrics in the information system can be appropriately assessed based on the obtained CVSS base value information and the countermeasure policy defining the countermeasure in view of the base value of the information system. Furthermore, by using these assessment results, it is possible to automatically determine whether or not the vulnerability needs to be addressed according to the information system.

### First Example Embodiment

Hereinafter, a first example embodiment will be described with reference to the drawings.

### <System Configuration>

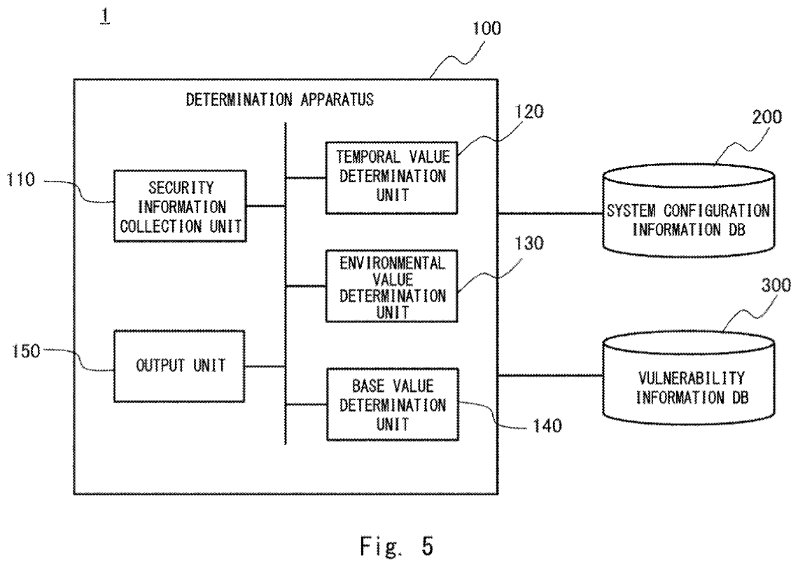

FIG. 5 shows a configuration example of the analysis system 1 according to this example embodiment. The analysis system 1 according to this example embodiment is a system for analyzing newly discovered vulnerabilities and determining whether or not countermeasures are needed on the information system.

As shown in FIG. 5, the analysis system (analysis apparatus) 1 includes a determination apparatus 100, a system configuration information DB (database) 200, and a vulnerability information DB 300. The system configuration information DB 200 and the vulnerability information DB 300 may be connected to the determination apparatus 100 via a network such as the Internet or may be directly connected to the determination apparatus 100. The system configuration information DB 200 and the vulnerability information DB 300 may be storage devices incorporated in the determination apparatus 100.

The system configuration information DB 200 is a database for previously storing system configuration information of the information system for determining whether or not a vulnerability needs to be addressed. The system configuration information includes hardware information, software information, network information, various setting information, and the like of node devices (terminals) constituting the information system. Further, the system configuration information includes information indicating which node device is an important asset (a critical asset) or the like as needed.

The vulnerability information DB 300 is a database for storing discovered (disclosed) vulnerability information. The vulnerability information includes, for example, target products, vulnerability details, CVSS base value information, and temporal value information for each vulnerability. In addition, the vulnerability information DB 300 may store intelligence information (measure information, etc.) about vulnerabilities. The vulnerability information DB 300 may store not only vulnerability information disclosed by public organizations such as IPA, CVE, NVD, and JVN (Japan Vulnerability Notes), but also vulnerability information disclosed by security vendors and other vendors. In addition, a configuration of the storage is not limited to a database and instead may be any configuration such as a blog as long as publicly disclosed vulnerability information or the like can be obtained.

The determination apparatus 100 includes a security information collection unit 110, a temporal value determination unit 120, an environmental value determination unit 130, a base value determination unit 140, and an output unit 150. If the operation described later is possible, other configurations may be used.

The security information collection unit 110 collects security information related to a vulnerability and a system. For example, the security information collection unit 110 obtains system information of the information system from the system configuration information DB 200, and obtains the vulnerability information from the vulnerability information DB 300.

The temporal value determination unit 120 is a temporal assessment unit that assesses the temporal metrics as regards a vulnerability in the information system, and determines whether or not the vulnerability in the information system needs to be addressed based on the publicly disclosed temporal value information of vulnerabilities as an assessment of the temporal metrics. The temporal value determination unit 120 determines whether or not the vulnerability needs to be addressed based on the publicly disclosed temporal value information of the vulnerabilities and the countermeasure determination table of the information system.

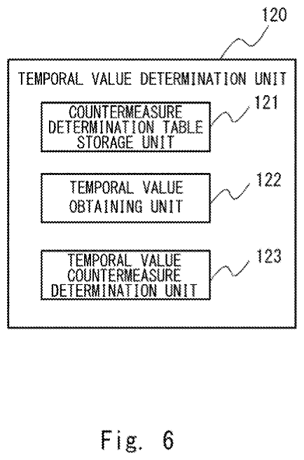

FIG. 6 shows an example of the configuration of the temporal value determination unit 120. As shown in FIG. 6, the temporal value assessment unit 120 includes a countermeasure determination table storage unit 121, a temporal value obtaining unit 122, and a temporal value countermeasure determination unit 123.

The countermeasure determination table storage unit 121 previously stores a countermeasure determination table (a temporal value countermeasure determination table showing temporal value countermeasure determination conditions) in which the temporal value information is associated with whether or not a countermeasure is needed on the information system. The countermeasure determination table may be a table for each information system or a table common to all information systems.

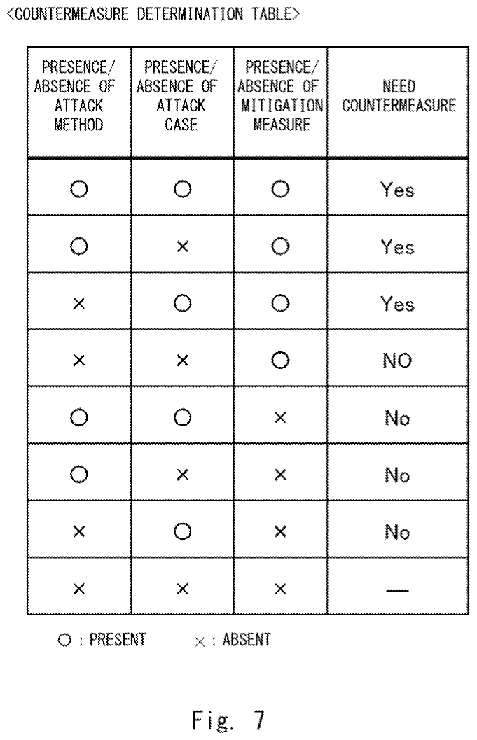

FIG. 7 shows a specific example of the stored countermeasure determination table. In the example of FIG. 7, in the countermeasure determination table (temporal value countermeasure determination conditions), “presence or absence of an attack method”, “presence or absence of an attack case”, and “presence or absence of a mitigation measure” included in the temporal value information are associated with the necessity of a countermeasure (Yes/No) on the information system. The “presence or absence of an attack method”, “presence or absence of an attack case”, and “presence or absence of a mitigation measure” are examples of factors for calculating the temporal value, and other factors may be included. Note that the countermeasure determination table is not limited to a format of the countermeasure determination table as long as the necessity of a countermeasure can be determined by the same association as that made by the countermeasure determination table (temporal value countermeasure determination conditions).

The temporal value obtaining unit 122 obtains temporal value information of a vulnerability to be analyzed from the vulnerability information DB 300 or the like. The temporal value obtaining unit 122 obtains the “presence or absence of an attack method”, “presence or absence of an attack case”, and the “presence or absence of a mitigation measure” included in the temporal value information of the vulnerability from the vulnerability information DB 300 and the vulnerability information and intelligence information of the vendor or the like.

Based on the obtained “presence or absence of an attack method”, “presence or absence of an attack case”, and “presence or absence of a mitigation measure”, the temporal value countermeasure determination unit 123 refers to the countermeasure determination table and determines whether or not a countermeasure is needed on the information system. For example, if an attack case of the temporal value information is present and a mitigation measure of the temporal value information is also present, the temporal value countermeasure determination unit 123 determines that the vulnerability needs to be addressed.

The environmental value determination unit 130 is an environment assessment unit that assesses the environmental metrics as regards a vulnerability in the information system, and determines whether or not the vulnerability in the information system needs to be addressed based on the attack path of the information system to which the vulnerability is applied as an assessment of the environmental metrics. The environmental value determination unit 130 determines whether or not the vulnerability needs to be addressed based on the attack path extracted from the attack graph of the information system to which the vulnerability is applied.

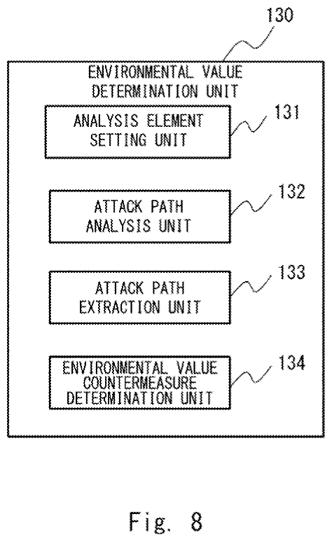

FIG. 8 shows a configuration example of the environmental value determination unit 130. As shown in FIG. 8, the environmental value determination unit 130 includes an analysis element setting unit 131, an attack path analysis unit 132, an attack path extraction unit 133, and an environmental value countermeasure determination unit 134.

In order to generate the attack graph, the analysis element setting unit 131 sets analysis elements such as an entry point of the attack path in the information system and an attack target. For example, the analysis elements may be set in advance or may be set by a user operation or the like. The attack path analysis unit 132 analyzes the attack path based on the analysis elements such as the set entry point and attack target.

The attack path extraction unit 133 generates the attack graph by using the attack graph generation technique (attack graph generation tool) based on the analysis result, and extracts the attack path including the vulnerability to be analyzed from the generated attack graph. The attack graph is a graph showing attack steps assumed for the information system to which the vulnerability to be analyzed is applied, and nodes passing through the attack steps in order from the entry point to the attack target are connected. A connection path of the nodes from the entry point to the attack target in the attack graph is the attack path.

For example, an attack path analysis is performed every time the vulnerability information is updated, such as when a new vulnerability is discovered, by setting the entry point and the attack target (important asset, etc.) in advance.

In the information system to which the vulnerability is applied, the environmental value countermeasure determination unit 134 determines whether or not a countermeasure is needed on the information system according to whether or not the attack path from the entry point to the attack target is extracted. That is, in this example embodiment, the environmental value is assessed based on whether or not the attack path from the entry point to the important asset (target) is present by deriving the attack path by using the attack graph analysis or the like instead of the numerical calculation defined by CVSS. For example, if the attack path can be extracted from the attack graph, the environmental value countermeasure determination unit 134 determines that the vulnerability needs to be addressed.

The base value determination unit 140 is a base assessment unit that assesses the base metrics as regards a vulnerability in the information system, and determines whether or not the vulnerability in the information system needs to be addressed based on publicly disclosed base value information of the vulnerabilities as an assessment of the base metrics. The base value determination unit 140 determines whether or not the vulnerability needs to be addressed based on the publicly disclosed base value information of the vulnerabilities and the policy determination table of the information system.

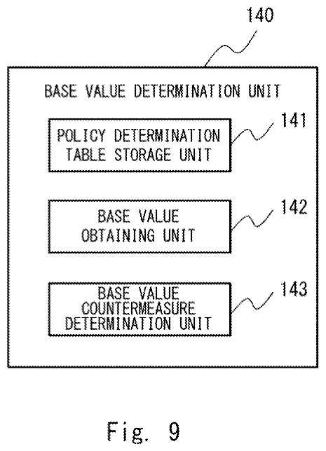

FIG. 9 shows a configuration example of the base value determination unit 140. As shown in FIG. 9, the base value determination unit 140 includes a policy determination table storage unit 141, a base value obtaining unit 142, and a base value countermeasure determination unit 143.

The policy determination table storage unit 141 previously stores the policy determination table (a base value countermeasure determination table showing base value countermeasure determination conditions) in which the base value information is associated with the necessity of a countermeasure on the information system. The policy determination table describes detailed information of the vulnerability and the characteristics of the information system. The policy determination table may be a table for each information system or a table for each important asset.

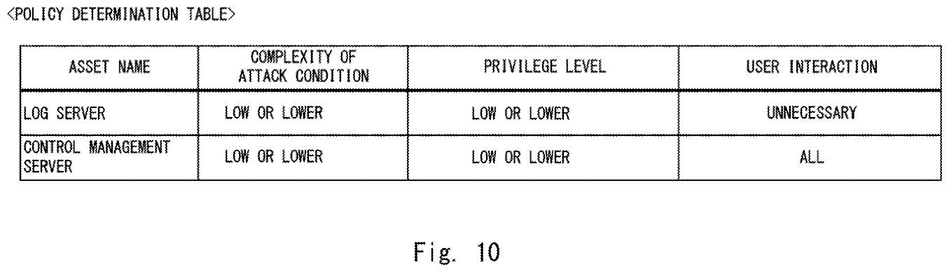

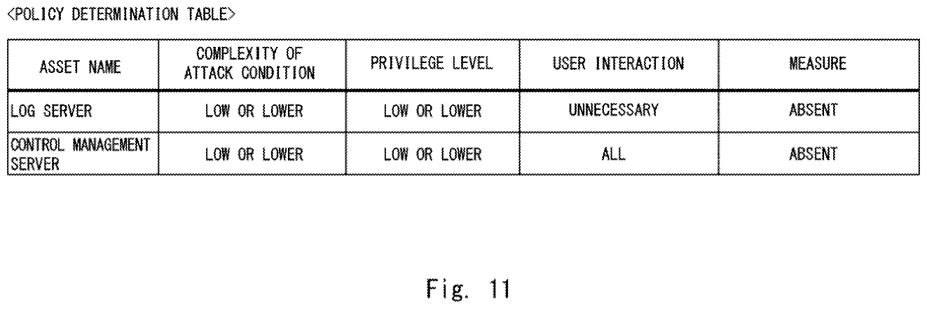

FIGS. 10 and 11 show specific examples of the stored policy determination tables. In the example of FIG. 10, in the policy determination table (base value countermeasure determination conditions), countermeasure conditions (system characteristics) are set for each “complexity of an attack condition”, “privilege level”, and “user interaction” included in the base value information for each important asset (asset name). The “complexity of an attack condition”, “privilege level”, and “user interaction” are examples of calculation factors of the base value, and other factors may be included. In the example of FIG. 11, information about the presence or absence of a “measure” is set in the policy determination table in addition to the countermeasure conditions of the “complexity of an attack condition”, “privilege level”, and “user interaction” for each important asset (asset name). As shown in FIG. 11, although not included in the base value information of the CVSS, measure information, attack detection methods, etc. included in the intelligence information may be included in the policy determination table. Note that the policy determination table is not limited to a format of the policy determination table as long as the necessity of a countermeasure can be determined by the same association as that made by the policy determination table (base value countermeasure determination conditions).

The base value obtaining unit 142 obtains the base value information of a vulnerability to be analyzed from the vulnerability information DB 300 or the like. The base value obtaining unit 142 obtains information such as the “complexity of an attack condition”, the “privilege level”, the “user interaction”, and other information such as a “measure” included in the base value information of the vulnerability from the vulnerability information DB 300 and the vulnerability information and intelligence information of the vendor or the like.

Based on the obtained information such as the “complexity of an attack condition”, the “privilege level”, the “user interaction”, and other information such as the “countermeasure”, the base value countermeasure determination unit 143 refers to the policy determination table to determine the necessity of a countermeasure on the information system. The necessity of a countermeasure is judged according to the vulnerability information based on contents of the determination related to the base value set in the policy determination table. For example, when information such as the “complexity of an attack condition” in the base value information corresponds to the “complexity of an attack condition” in the policy determination table, the base value countermeasure determination unit 143 determines that the vulnerability needs to be addressed.

The output unit 150 outputs, based on the determination results of the temporal value determination unit 120, the environmental value determination unit 130, and the base value determination unit 140, whether or not the vulnerability in the information system needs to be addressed. The output unit 150 outputs each of the determination results of the temporal value determination unit 120, the environmental value determination unit 130, and the base value determination unit 140. The output unit 150 is also a determination unit for determining whether or not the vulnerability needs to be addressed based on the determination results of the temporal value determination unit 120, the environmental value determination unit 130, and the base value determination unit 140. For example, the output unit 150 outputs all the results when all the determination results of the temporal value determination unit 120, the environmental value determination unit 130, and the base value determination unit 140 indicate that a countermeasure is needed. Alternatively, the output unit may output only the result indicating that a countermeasure is needed if any one of the determination results indicates so. The output method is not limited, and the determination result may be displayed on a display unit (display device) by a GUI (Graphical User Interface), or the user may be notified of data in any format indicating the determination result.

### <System Operation>

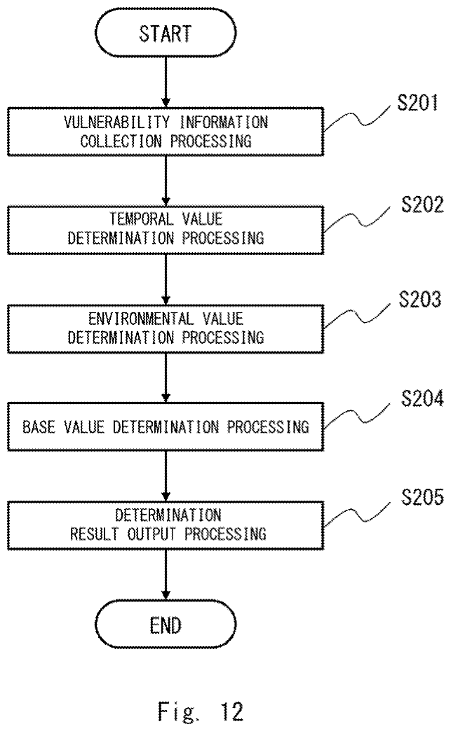

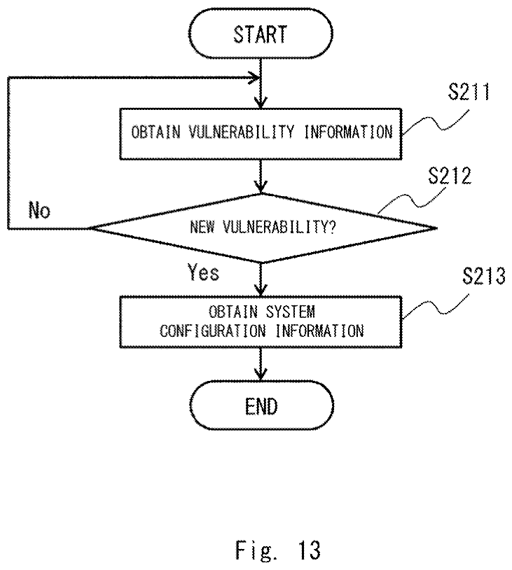

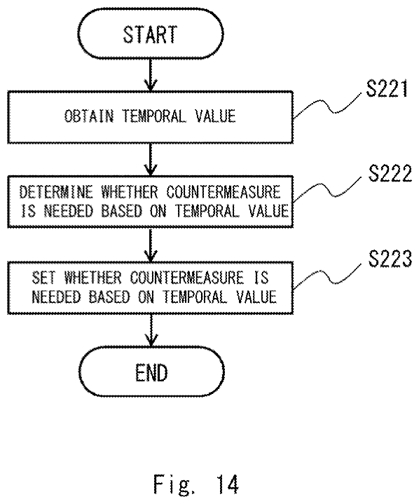

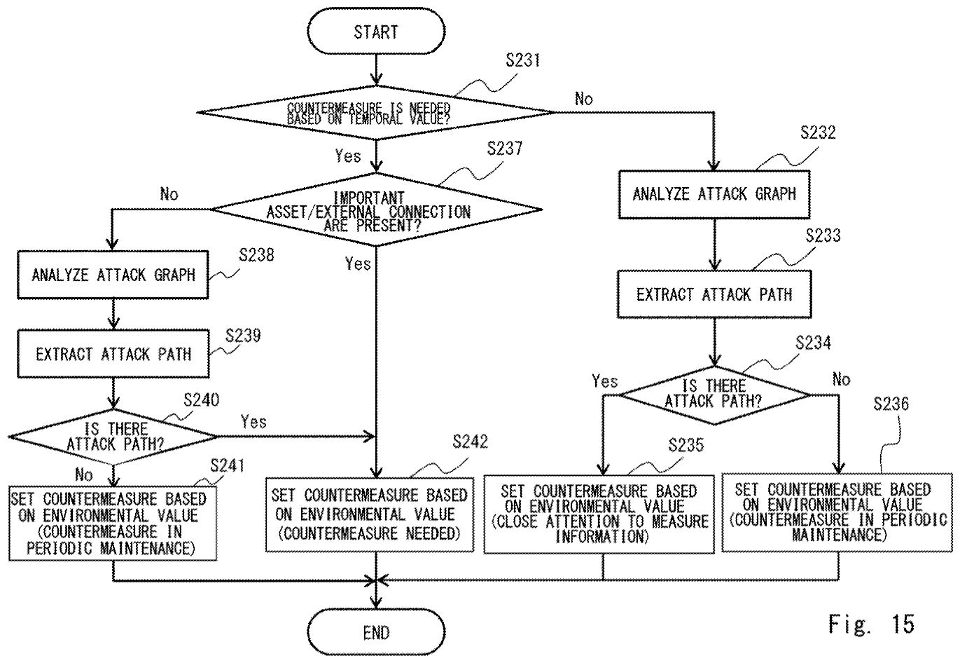

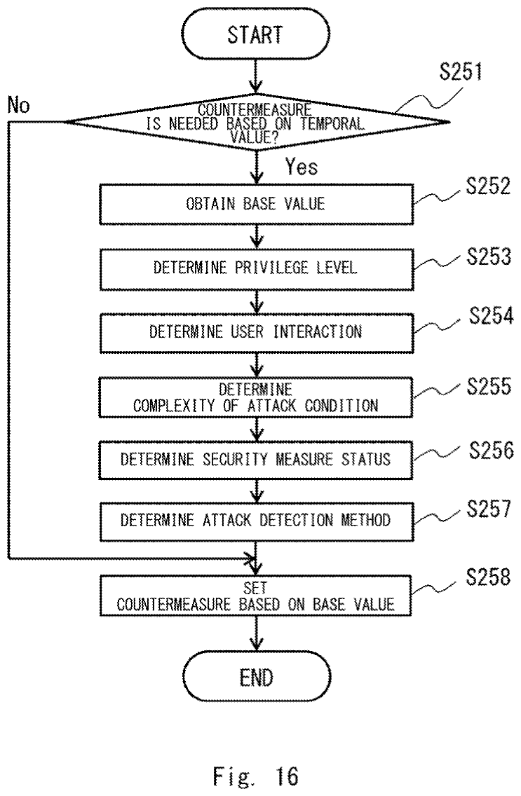

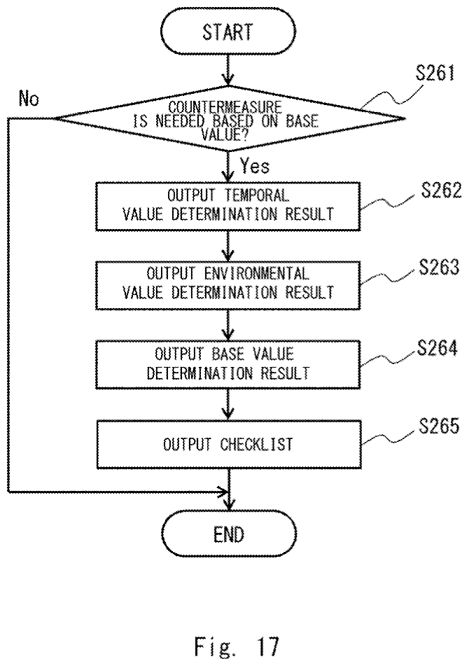

FIG. 12 shows an operation example (analysis method) of the analysis system 1 according to this example embodiment. FIG. 13 shows a flow of vulnerability information collection processing (S201) in FIG. 12, FIG. 14 shows a flow of the temporal value determination processing (S202) in FIG. 12, FIG. 15 shows a flow of environmental value determination processing (S203) in FIG. 12, FIG. 16 shows a flow of base value determination processing (S204) in FIG. 12, and FIG. 17 shows a flow of the determination result output processing (S205) in FIG. 12. Although the processing is performed in the order of the temporal value determination processing, the environmental value determination processing, and the base value determination processing, the processing may be performed in any order.

As shown in FIG. 12, the determination apparatus 100 performs the vulnerability information collection processing (S201). As shown in FIG. 13, in the vulnerability information collection processing, the security information collection unit 110 obtains the vulnerability information from the vulnerability information DB 300, such as a public database (S211), and determines whether or not a new vulnerability has been discovered (S212). The security information collection unit 110 may periodically refer to the vulnerability information DB 300 or may obtain an alert notification of new vulnerability information from IPA or the like.

When a new vulnerability is discovered, the security information collection unit 110 obtains the system configuration information of the system configuration information DB 200 in order to analyze whether or not the new vulnerability in the user's information system needs to be addressed (S213). In addition, the security information collection unit 110 obtains the intelligence information about the vulnerability and the like from, for example, the vulnerability information DB 300 and the vendor.

Next, the determination apparatus 100 performs the temporal value determination processing (S202). As shown in FIG. 14, in the temporal value determination processing, the temporal value obtaining unit 122 obtains the temporal value (temporal value information) of the vulnerability to be analyzed (S221). For example, the temporal value information (“presence or absence of an attack method”, “presence or absence of an attack case”, and “presence or absence of a mitigation measure”, etc.) is extracted from the vulnerability information obtained in the security information collection processing.

Next, the temporal value countermeasure determination unit 123 determines whether or not a countermeasure is needed based on the obtained temporal value (S222). The temporal value countermeasure determination unit 123 refers to the countermeasure determination table as shown in FIG. 7, and determines whether or not a countermeasure is needed based on the obtained temporal value information. For example, referring to the countermeasure determination table, if the attack case included in the obtained information about the current vulnerability value is “present” and the mitigation measure is “present”, it is determined that a countermeasure is needed in view of the current vulnerability value, because an immediate measure is required. In other cases, it is determined that no countermeasure is needed in view of the temporal value. Further, the temporal value countermeasure determination unit 123 sets the necessity of a countermeasure based on the determined temporal value in a storage unit or the like of the determination apparatus 100 in order to make it possible to refer to the temporal value in the subsequent processing (S223).

Next, the determination apparatus 100 performs the environmental value determination processing (S203). As shown in FIG. 15, in the environmental value determination processing, the attack graph is analyzed according to the necessity of a countermeasure based on the temporal value (S231).

When it is determined that a countermeasure is not needed based on the temporal value, that is, when the attack case is “absent” or the mitigation measure is “absent”, the attack graph is analyzed in order to determine whether or not a periodic maintenance countermeasure is to be performed (S232). For example, the analysis element setting unit 131 sets the analysis elements such as the entry point of the attack path and the attack target, and the attack path analysis unit 132 analyzes the attack path based on the set analysis elements.

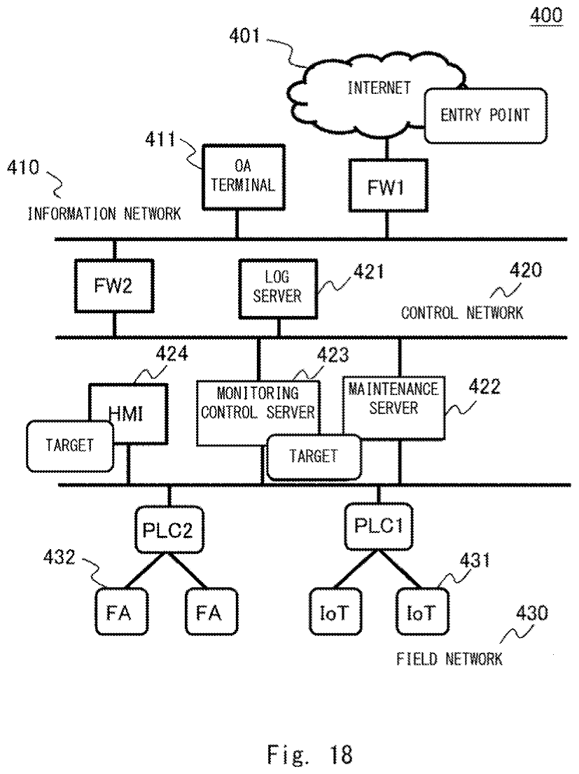

For example, in the system configuration of the information system 400 shown in FIG. 18, the analysis elements such as the entry point and the attack target are set in advance. Alternatively, the user may select the nodes and the set analysis elements such as the entry point and the attack target. In the example of FIG. 18, the information system 400 is a production management system including an information network 410, a control network 420, and a field network 430. The information network 410 is connected to the Internet 401 via a firewall FW1 and includes an OA terminal 411. The control network 420 is connected to the information network 410 via a firewall FW2, and includes a log server 421, a maintenance server 422, a monitoring control server 423, and an HMI (Human Machine Interface) 424. The field network 430 is connected to the control network 420 via programmable logic controllers PLC 1 and PLC 2, and includes an IoT device 431, a Factory Automation (FA) device 432, and so on. For example, in the information system 400, the Internet 401 is set as an entry point for an attack, and the monitoring control server 423 and the HMI 424 are set as attack targets.

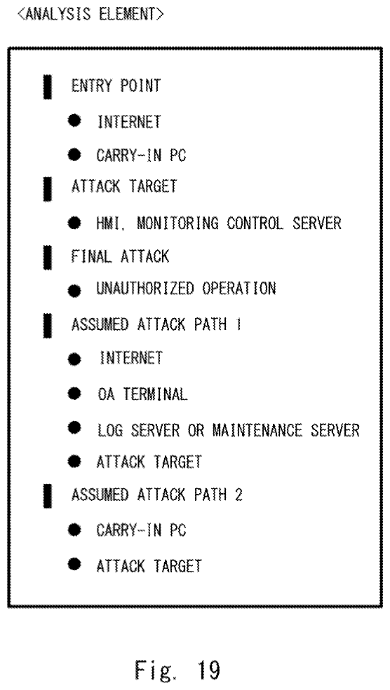

The attack path analysis unit 132 may analyze the attack path from the set entry point and the attack target, or may analyze the attack path optionally designated. For example, as shown in FIG. 19, as the analysis elements, in addition to the entry point and the attack target, a final attack (attack result), an assumed attack path between nodes, and the like are set, and then the attack path is analyzed.

Further, the attack path extraction unit 133 extracts the attack path (S233). The attack path extraction unit 133 generates the attack graph by using the attack graph generation technique based on the set and analyzed information, and extracts the attack path of the information system including a vulnerability of the analysis target. That is, by inputting the system configuration information to which the newly discovered vulnerability to be analyzed is applied in addition to existing vulnerabilities, the entry point, the attack target, and the like to the attack graph generation technique, the attack graph from the entry point to the attack target passing through the vulnerability of each node is generated.

Then, in S233, the environmental value countermeasure determination unit 134 determines whether or not the attack path has been extracted from the attack graph (S234), and when the attack path has been extracted (when an urgent measure is needed regardless of the important asset), it determines that a countermeasure is not needed in view of the environmental value and that close attention is necessary to the measure information, and sets whether or not a countermeasure is needed based on the determined environmental value (S235). When the attack path is not extracted (when neither the mitigation measure for the vulnerability nor the risk is present), the environmental value countermeasure determination unit 134 determines that a countermeasure is not needed in view of the temporal value and the environmental value, and determines that a countermeasure is needed in the periodic maintenance based on the determined environmental value (S236).

On the other hand, when it is determined that a countermeasure is needed based on the temporal value, that is, when the attack case is “present” and the mitigation measure is “present”, the attack graph is analyzed according to whether or not there is an important asset and an external connection to the information system (S237).

When the system configuration information is referred to and there is no important asset having a vulnerability in the information system or there is no external connection to the important asset, the attack graph is analyzed in order to determine whether or not a countermeasure is needed based on the environmental value (S238). As in S232 and S233, the analysis element setting unit 131 sets the analysis element, and the attack path analysis unit 132 analyzes the attack path based on the set analysis elements. Further, the attack path extraction unit 133 extracts the attack path of the information system including a vulnerability to be analyzed based on the set and analyzed information (S239).

Then, in S239, the environmental value countermeasure determination unit 134 determines whether or not the attack path has been extracted (S240), and if the attack path has been extracted (if there is a risk of a vulnerability), it determines that a countermeasure is needed in view of the environmental value (and the temporal value), and sets whether or not a countermeasure is needed based on the determined environmental value (S242). When the attack path is not extracted (when there is no risk of a vulnerability), the environmental value countermeasure determination unit 134 determines that a countermeasure is not needed in view of the environmental value and that a countermeasure is to be taken in the periodic maintenance, and sets whether or not a countermeasure is needed based on the determined environmental value (S241).

Also, when there is an important asset having a vulnerability in the information system and there is an external connection to the important asset, the environmental value countermeasure determination unit 134 determines that a countermeasure is needed in view of the environmental value (and the temporal value), and sets whether or not a countermeasure is needed based on the determined environmental value (S242).

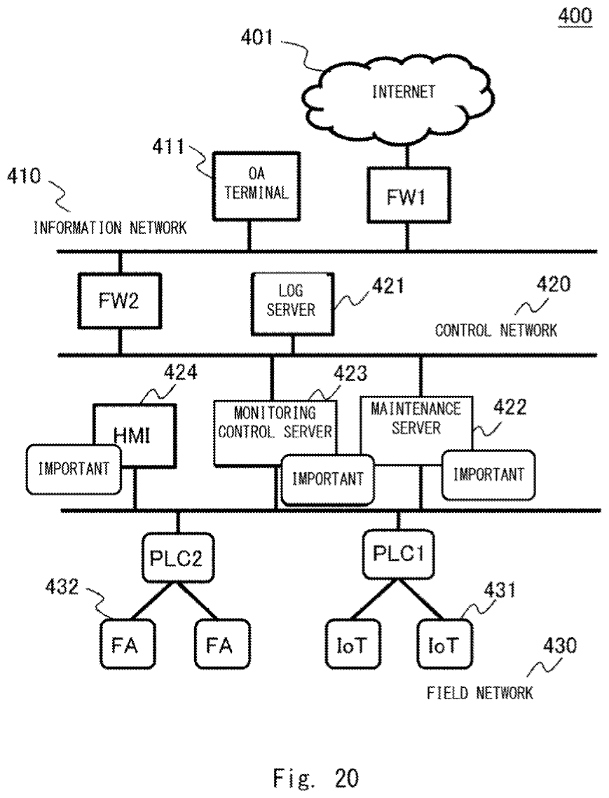

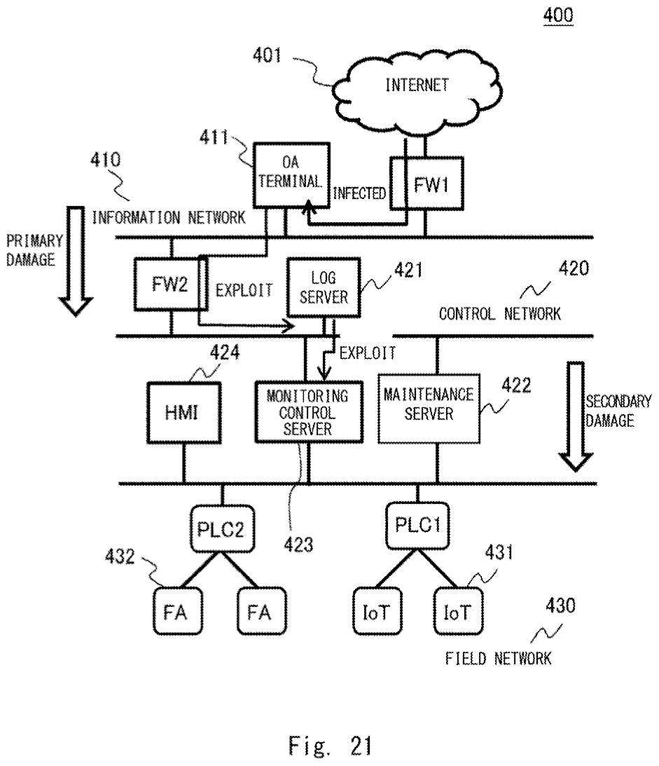

FIGS. 20 and 21 show specific examples of environmental value assessment using an attack path. For example, as shown in FIG. 20, in the information system 400, when the maintenance server 422, the monitoring control server 423, and the HMI 424 are important assets, it is assumed that a vulnerability is present in the monitoring control server 423. Although the monitoring control server 423 is an important asset, it cannot be directly accessed from the OA terminal 411 because of the FW2 and has no external connection. Thus, the attack graph is analyzed, and the attack path from the Internet 401 to the monitoring control server 423 is not extracted, and it is therefore determined that a countermeasure against the vulnerability is not needed (S241). That is, in this case, since the monitoring control server 423 is isolated by the FW2, the countermeasure is suspended.

On the other hand, as shown in FIG. 21, it is assumed that a new vulnerability is subsequently discovered and the vulnerability is present in the log server 421, which is a non-important asset. Next, the attack graph is analyzed, and the attack path from the Internet 401 to the monitoring control server 423 is extracted, and thus it is determined that the vulnerability needs to be addressed (S242). That is, when a vulnerability is found in the log server 421, which is the non-important asset, the attack path leading to the monitoring control server 423, which is the important asset, is detected, and it is determined that there is secondary damage to the important asset in addition to primary damage to the log server 421.

Next, the determination apparatus 100 performs the base value determination processing (S204). As shown in FIG. 16, in the base value determination processing, the base value information is analyzed according whether or not a countermeasure is needed based on the environmental value (and the temporal value) (S251).

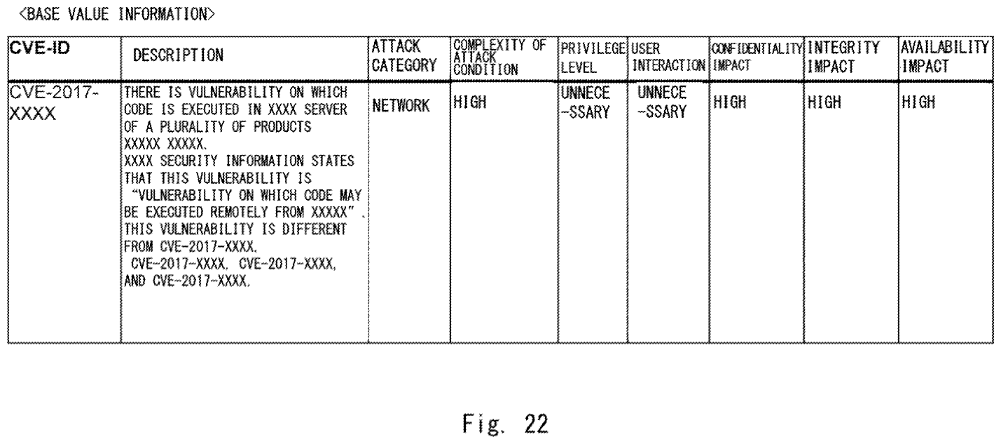

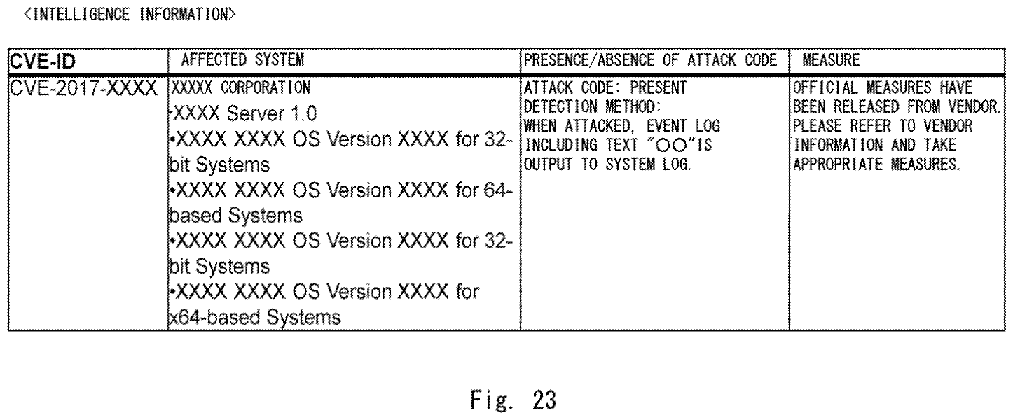

When it is determined that a countermeasure is needed based on the environmental value, the base value obtaining unit 142 obtains the base value (base value information) and the like of the vulnerability to be analyzed (S252). For example, the base value information is extracted from the vulnerability information obtained in the security information collection processing, and necessary information is extracted from the intelligence information. FIG. 22 shows a specific example of the obtained base value information of the vulnerability. In the example in FIG. 22, for each vulnerability information (CVE-ID), a “description”, an “attack category”, “complexity of an attack condition”, a “privilege level”, “user interaction”, a “confidentiality impact”, an “integrity impact”, and an “availability impact” of the vulnerability are included. FIG. 23 shows a specific example of the obtained vulnerability intelligence information. In the example in FIG. 23, for each vulnerability information (CVE-ID), an “affected system”, “presence or absence of an attack code”, and a “measure” are included.

Next, the base value countermeasure determination unit 143 determines whether or not a countermeasure is needed based on the obtained base value and the like (S252 to S257). The base value countermeasure determination unit 143 refers to the policy determination table shown in FIGS. 10 and 11, and determines whether or not a countermeasure is needed based on the obtained base value information and the like. In FIG. 16, as an example, a determination is made based on the privilege level (S253), the user interaction (S254), the complexity of the attack condition (S255), the security measure status (S256), and the attack detection method (S257). The order of these processes is not particularly limited, and the processes may be performed in any order, or a plurality of processes may be performed in parallel. A determination may be made based also on other information included in the obtained base value information and the like. For example, the “confidentiality impact”, the “integrity impact”, the “availability impact” and the like included in the base value information may be used.

In the determination of the privilege level (S253), whether or not a countermeasure is needed is determined based on whether or not the “privilege level” of the base value information of the vulnerability matches the “privilege level” of the policy determination table (whether or not the “privilege level” of the base value information of the vulnerability is included in the policy). By determining the privilege level, it is confirmed whether or not the necessity of authentication and administrator privilege (whether or not access to secret information is needed or the like) of the base value of the vulnerability matches that of the policy of the information system (whether or not the necessity of authentication and administrator privilege of the base value of the vulnerability is included in the policy). For example, in the policy of the information system, if the privilege level necessary for the attack of the vulnerability cannot be obtained, it is determined that an immediate countermeasure is not needed. For example, the privilege levels include a plurality of levels, such as unnecessary, low, medium, and high. In the vulnerability information of FIG. 22, the privilege level is “unnecessary”, and in the policy determination table of FIG. 10, the privilege levels of the log server and the control management server are “low or lower” and include “unnecessary”, and thus it is determined that a countermeasure is not needed.

In the determination of the user interaction (S254), whether or not a countermeasure is needed is determined based on whether the “user interaction” of the base value information of the vulnerability matches the “user interaction” in the policy countermeasure table. Based on the determination of the user interaction, it is confirmed whether or not a user action such as clicking a link, browsing a file, and changing a setting is needed, which is defined in the base value of the vulnerability, matches that of the policy of the information system. For example, if the base value of the vulnerability requires the user's operation and the policy of the information system allows the user's operation, it is determined that a countermeasure is needed to convey the risk. If the base value of the vulnerability requires the user's operation, and the policy of the information system does not allow the user's operation, it is determined that an immediate countermeasure is not needed. In the vulnerability information of FIG. 22, the user interaction is “necessary”, and in the policy determination table of FIG. 10, the user interaction of the log server is “unnecessary”, and the user interaction of the control management server is “all” (including both necessary and unnecessary). Thus, it is determined that a countermeasure on the management control server is needed.

In the determination of the complexity of the attack condition (S255), it is determined whether or not a countermeasure is needed based on whether the “complexity of the attack condition” of the base value information of the vulnerability matches the “complexity of the attack condition” of the policy countermeasure table (whether or not the “complexity of the attack condition” of the base value information of the vulnerability is included in the policy). Based on the determination of the complexity of the attack condition, it is confirmed whether or not information (configuration information, sequence number, shared key, etc.) necessary for a successful attack in the base value of the vulnerability matches that of the policy of the information system (whether or not information necessary for a successful attack in the base value of the vulnerability is included in the policy). For example, if it is difficult to obtain the information necessary for a successful attack based on the base value of the vulnerability, and the policy of the information system requires information necessary for a successful attack, it is determined that an immediate countermeasure is not needed. For example, the complexity of the attack condition includes a plurality of steps such as none, low, medium, and high. In the vulnerability information of FIG. 22, the complexity of the attack condition is “high”, and in the policy determination table of FIG. 10, the complexity of the attack condition of the log server and the control management server is “low or lower”, and thus it is determined that no countermeasure is needed.

In determining the security measure status (S256), whether or not a countermeasure is needed is determined based on whether the “measure” of the vulnerability intelligence information matches the “measure” of the policy countermeasure table. Based on the determination of the security measure status, it is confirmed whether or not the necessity of a measure such as virtual patches of the intelligence information of the vulnerability matches that of the policy of the information system. For example, if there is a measure (IDS/IPS, virtual patches) against a vulnerability that is exploited in an attack in the intelligence information of the vulnerability, and the policy of the information system does not require a measure, it is determined that an immediate countermeasure is not needed. In the vulnerability information of FIG. 23, the measures are “publicly disclosed”, and in the policy determination table of FIG. 11, measures of the attack conditions in the log server and the control management server are “absent”, and thus it is determined that a countermeasure is not needed.

In the determination of the attack detection method (S257), it is determined whether or not a countermeasure is needed based on whether the “presence or absence of the attack code” of the intelligence information of the vulnerability matches the “presence or absence of the attack code” of the policy countermeasure table. Based on the determination of the attack detection method, it is confirmed whether or not the necessity of a method for detecting an attack, such as an attack code log generated when a vulnerability is exploited in the intelligence information of the vulnerability matches that of the policy of the information system. For example, if it is determined that there is a log in the intelligence information of the vulnerability and the policy of the information system defines that this log is to be collected, the log is temporarily monitored (it is determined that a countermeasure is needed).

When the necessity of a countermeasure is determined based on the information of the base value, the base value countermeasure determination unit 143 sets whether or not a countermeasure is needed based on the determined base value (S258). For example, the respective determination results of S253 to S257 are set. Note that when it is determined that a countermeasure is not needed based on the environmental value, it is determined that a countermeasure regarding the base value is not also needed.

Next, the determination apparatus 100 performs the determination result output processing (S205). As shown in FIG. 17, in the determination result output processing, the determination results are output according whether or not a countermeasure is needed based on the base values (the temporal value and the environmental value) (S261).

If it is determined that a countermeasure is not needed based on the base value (if it is determined that a countermeasure is needed based on any information of the reference value), that is, if it is determined that a countermeasure is needed in all of the temporal value determination processing, the environmental value determination processing, and the base value determination processing, the output unit 150 outputs all the determination results. In this example, in addition to the determination result of the temporal value (S262), the determination result of the environmental value (S263), and the determination result of the base value (S264), a checklist of the vulnerability (S265) is output. The order of outputting the determination results is not limited to this, and may be output in any order, or a plurality of pieces of information may be collectively output.

The checklist is a checklist of items to be checked for vulnerabilities. For example, the items to be checked include an IDS (Intrusion Detection System)/IPS (Intrusion Prevention System), a signature of a virtual patch, etc., detailed conditions for checking whether or not a vulnerability should be checked and so on (information necessary to determine whether it is definitely needed to check for a vulnerability, for example, information about whether a service has been started, etc.).

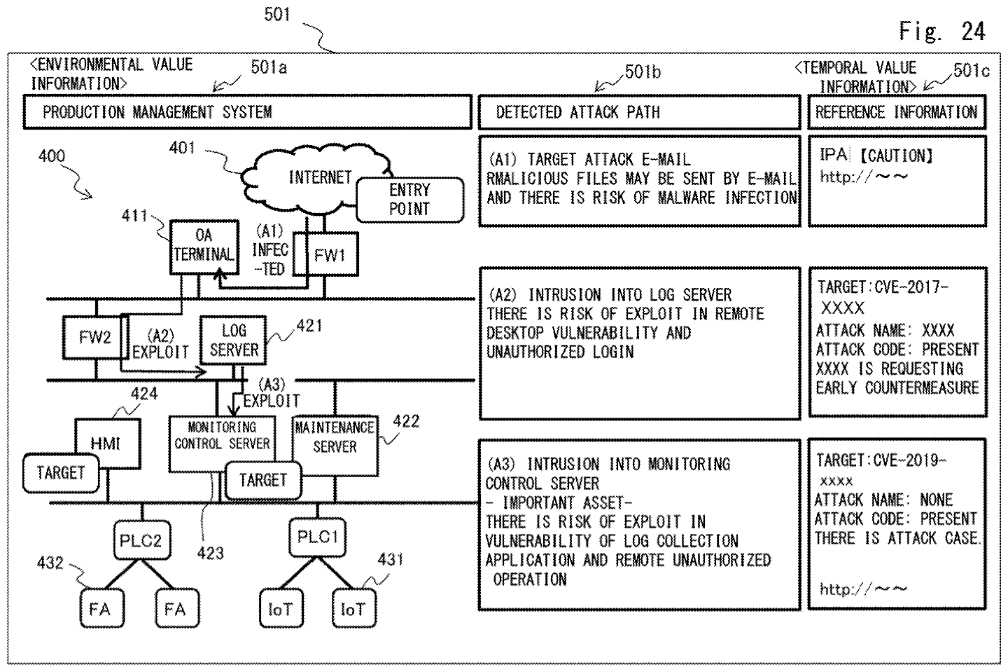

FIG. 24 is an output example of the determination results of the environmental value and the temporal value. For example, as shown in FIG. 24, the output unit 150 displays the determination results of the environmental value and the temporal value on a display screen 501. A report showing an image of the display screen 501 may be transmitted. In the example of FIG. 24, the display screen 501 includes a system information display area 501a, an attack path information display area 501b, and a reference information display area 501c. The environmental value information (extracted attack path) is displayed in the system information display area 501a and the attack path information display area 501b, and the temporal value information (temporal measure information, etc.) is displayed in the reference information display area 501c.

In the system information display area 501a, the system configuration of the information system 400 in which the vulnerability has been analyzed is displayed, the set entry point and attack target are displayed, and the extracted attack path from the entry point to the attack target is displayed. That is, in the system information display area 501a, the attack path which is determined that a countermeasure is needed based on the environmental value is displayed. Attack steps (attack procedure) of the analyzed attack path are displayed. For example, in an attack step A1, it is displayed that the OA terminal 411 is infected by an email, in an attack step A2, it is displayed that the log server 421 may be intruded, and in an attack step A3, it is displayed that a vulnerability may be exploited in the monitoring control server 423.

In the attack path information display area 501b, detailed information (danger, etc.) about the attack path displayed in the system information display area 501a is displayed. The detailed information is displayed corresponding to the attack steps of the attack path displayed in the system information display area 501a. For example, in the display of the attack step A1, it is explained that there is a risk that the OA terminal 411 may be attacked. In the display of the attack step A2, it is explained that there is a risk of intrusion into the log server 421. In the display of the attack step A3, it is explained that after the attack step A2, there is a risk of intrusion into the monitoring control server 423 set as the attack target.

The reference information for the detailed information of the attack path displayed in the attack path information display area 501b is displayed in the reference information display area 501c. In a manner similar to the attack path information display area 501b, the detailed information is displayed corresponding to the attack steps of the attack path. In other words, the temporal value information of the vulnerability which is determined that it needs to be addressed based on the temporal value and the environmental value is displayed in the reference information display area 501c. For example, link information (information source) about a website publicly disclosing the vulnerabilities, an attack method, an attack case, a mitigation measure, and the like are displayed as the information about the temporal value. For example, in the display of the attack step A1, information about the vulnerability that may be exploited for attacking the OA terminal 411 is displayed, in the display of the attack step A2, information about the vulnerability that may be exploited for intruding the log server 421 is displayed, and in the display of the attack step A3, information about the vulnerability that may be exploited for intruding the monitoring control server 423 is displayed.

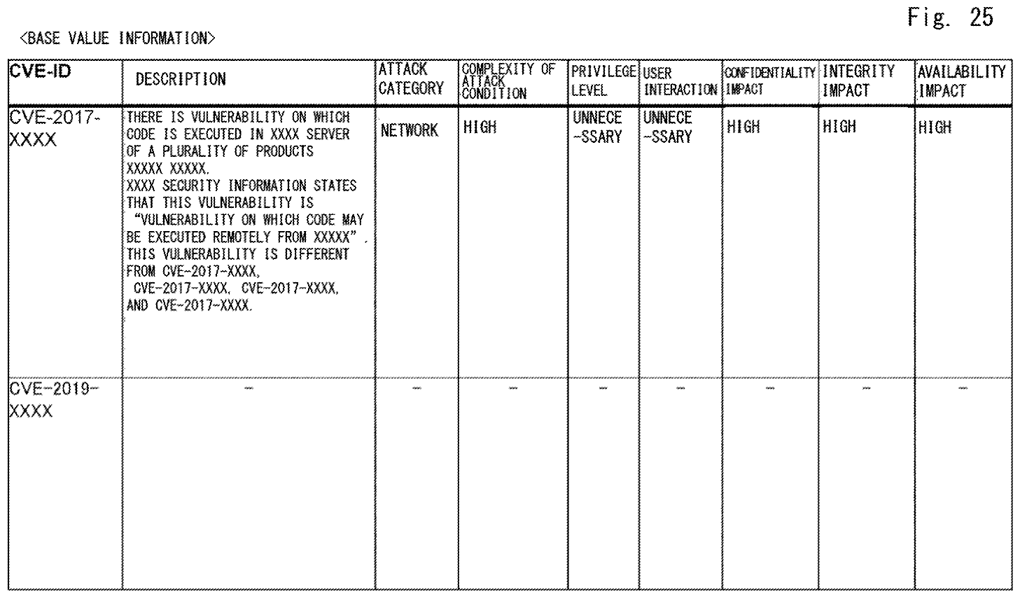

FIG. 25 is an output example of the determination result of the base value. As shown in FIG. 25, for example, the output unit 150 outputs, in any format, the base value information of the vulnerability determined to be addressed as a result of the determination based on the base value. The base value information to be output is the same as the base value information shown in FIG. 22, and for example, parts corresponding to the policy determination table are displayed differently (e.g., in bold, red letters, etc.).

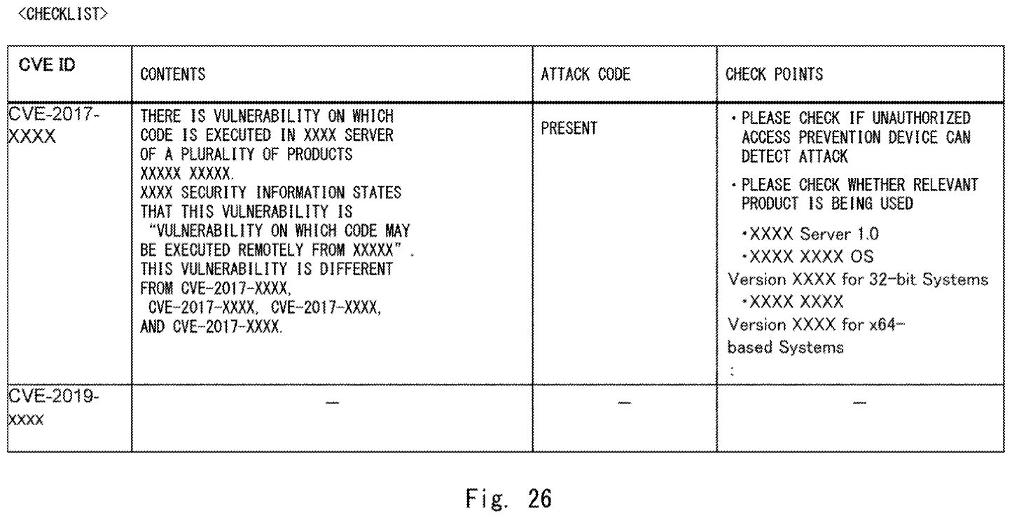

FIG. 26 is an output example of the checklist. As shown in FIG. 26, for example, the output unit 150 outputs the base value information and the intelligence information about the vulnerability collected as the determination based on the base value in any format. In the example of FIG. 26, the checklist includes “contents”, “attack code”, and “check points” for each vulnerability. The “contents” are the “description” of the base value information. The “attack code” is the “presence or absence of an attack code” of the intelligence information. The “check points” are information corresponding to the “affected system” of the intelligence information.

### <Effect>

As described above, in this example embodiment, in determining whether or not a vulnerability needs to be addressed using the CVSS metrics, the environmental value is assessed by extracting the attack path by using the attack graph technique, and it is determined whether or not the vulnerability needs to be addressed. The temporal value and the base value are assessed by using the countermeasure determination table and the policy determination table that define the temporal value, the base value, and the countermeasure on the information system to determine whether or not a countermeasure is needed. Furthermore, for example, if it is determined that a countermeasure is needed based on the determination results of the environmental value, the temporal value, and the base value, the determination results are output and can be visualized.

By doing so, it is possible to automatically determine whether or not a vulnerability newly discovered on a daily basis needs to be addressed. By determining whether or not a vulnerability needs to be addressed and outputting a result of the determination instead of the numerical values of the environmental value, the temporal value, and the base value, the user can have specific understanding of a vulnerability which needs to be addressed. For example, as for the environmental value, whether or not a countermeasure is needed is determined depending on the presence or absence of the attack path, and then the attack path is output. Thus, the degree of damage by the attack can be visualized, and the user can clearly understand the affected range and the reason why a countermeasure is required.

In addition, by using the countermeasure determination table and the policy determination table that define countermeasures on the information system, the base value and the temporal value can be assessed according to the information system. By outputting the reference information and the base value information of the temporal value as the information of the vulnerability which needs to be addressed, the user can obtain the necessary information collectively. Furthermore, by outputting the checklist of vulnerabilities, the user can acquire items to be checked.

For example, it is difficult to make an assessment suitable for the current information system if an assessment is made based on only the base value. However, by assessing the environmental value and the temporal value in addition to the base value, it is possible to appropriately determine whether or not a countermeasure is needed. By combining the determination results of the base value, the environmental value, and the temporal value, it is possible to prevent an output of unnecessary vulnerability information and enable an output of only necessary vulnerability information.

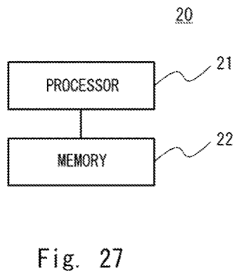

Each of the configurations in the above-described example embodiments is constituted by hardware and/or software, and may be constituted by one piece of hardware or software, or may be constituted by a plurality of pieces of hardware or software. As shown in FIG. 27, each apparatus and each function (processing) may be implemented by a computer 20 including a processor 21 such as a CPU (Central Processing Unit) and a memory 22 as a storage device. For example, programs (analysis programs) for performing the method according to the example embodiments may be stored in the memory 22, and each function may be implemented by the processor 21 executing the programs stored in the memory 22.

These programs can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (Read Only Memory), CD-R (compact disc recordable), CD-R/W (compact disc rewritable), and semiconductor memories (such as mask ROM, PROM (Programmable ROM), EPROM (Erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The present disclosure is not limited to the above-described example embodiments, and may be modified as appropriate without departing from the spirit.

Although the present disclosure has been described with reference to the example embodiments, the present disclosure is not limited to the example embodiments. The configuration and details of the present disclosure may be modified in various ways that will be understood by those skilled in the art within the scope of the present disclosure.

The whole or part of the example embodiments disclosed above can be described as, but not limited to, the following supplementary notes.

### (Supplementary Note 1)

An analysis apparatus comprising:

environment assessment means for assessing environmental metrics of a Common Vulnerability Scoring System (CVSS) as regards a vulnerability in an information system based on an attack path extracted from the information system to which the vulnerability to be analyzed is applied;

base assessment means for assessing base metrics of the CVSS as regards the vulnerability in the information system based on obtained CVSS base value information of the vulnerability and a predetermined base value countermeasure determination condition of the information system; and

determination means for determining whether or not the vulnerability in the information system needs to be addressed based on an assessment result of the environmental metrics and an assessment result of the base metrics.

### (Supplementary Note 2)

The analysis apparatus according to Supplementary note 1, wherein

the environment assessment means determines whether or not the vulnerability in the information system needs to be addressed as the assessment of the environmental metrics.

### (Supplementary Note 3)

The analysis apparatus according to Supplementary note 2, wherein

the environment assessment means generates an attack graph based on the information system to which the vulnerability is applied, and extracts an attack path from the generated attack graph.

### (Supplementary Note 4)

The analysis apparatus according to Supplementary note 3, wherein

the environment assessment means determines that the vulnerability needs to be addressed when the attack path can be extracted from the attack graph.

### (Supplementary Note 5)

The analysis apparatus according to any one of Supplementary notes 2 to 4, wherein

the environment assessment means extracts the attack path according to presence or absence of an important asset including the vulnerability in the information system and presence or absence of an external connection to the important asset.

### (Supplementary Note 6)

The analysis apparatus according to Supplementary note 5, wherein

the environment assessment means extracts the attack path when there is no important asset including the vulnerability in the information system or when there is no external connection to the important asset.

### (Supplementary Note 7)

The analysis apparatus according to Supplementary note 5 or 6, wherein

the environment assessment means determines that the vulnerability needs to be addressed when there is the important asset including the vulnerability in the information system and there is the external connection to the important asset.

### (Supplementary Note 8)

The analysis apparatus according to any one of Supplementary notes 1 to 7, further comprising:

temporal assessment means for assessing temporal metrics of the CVSS as regards the vulnerability in the information system based on obtained CVSS temporal value information of the vulnerability and a predetermined temporal value countermeasure determination condition of the information system, wherein

the determination means determines whether or not the vulnerability in the information system needs to be addressed based on the assessment result of the environmental metrics, the assessment result of the base metrics, and an assessment result of the temporal metrics.

### (Supplementary Note 9)

The analysis apparatus according to Supplementary note 8, wherein

the temporal assessment means determines whether or not the vulnerability in the information system needs to be addressed as the assessment of the temporal metrics.

### (Supplementary Note 10)

The analysis apparatus according to Supplementary note 9, wherein

the temporal value countermeasure determination condition is a condition that associates a temporal value calculation element of the CVSS temporal value information with whether or not the vulnerability in the information system needs to be addressed.

### (Supplementary Note 11)

The analysis apparatus according to Supplementary note 10, wherein

the temporal value calculation element includes presence or absence of an attack method, presence or absence of an attack case, or presence or absence of a mitigation measure.

### (Supplementary Note 12)

The analysis apparatus according to Supplementary note 11, wherein

when there are the attack case of the CVSS temporal value information and the mitigation measure of the CVSS temporal value information, the temporal assessment means determines that the vulnerability needs to be addressed.

### (Supplementary Note 13)

The analysis apparatus according to any one of Supplementary notes 1 to 12, wherein

the base assessment means determines whether or not the vulnerability in the information system needs to be addressed as the assessment of the base metrics.

### (Supplementary Note 14)

The analysis apparatus according to Supplementary note 13, wherein

the base value countermeasure determination condition is a condition in which a system characteristic in the information system is associated with each base value calculation element of the CVSS base value information.

### (Supplementary Note 15)

The analysis apparatus according to Supplementary note 14, wherein

when information about the base value calculation element of the CVSS base value information corresponds to the system characteristic of the base value countermeasure determination condition, the base assessment means determines that the vulnerability needs to be addressed.

### (Supplementary Note 16)

The analysis apparatus according to Supplementary note 14 or 15, wherein

the base value calculation element includes complexity of an attack condition, a privilege level, or user interaction.

### (Supplementary Note 17)

The analysis apparatus according to Supplementary note 14 or 15, wherein

the base value countermeasure determination condition further includes presence or absence of measure information and presence or absence of an attack detection method.

### (Supplementary Note 18)

The analysis apparatus according to any one of claims 1 to 17, further comprising:

output means for outputting the assessment result of the environmental metrics and the assessment result of the base metrics according to a result of determining whether or not the vulnerability needs to be addressed.

### (Supplementary Note 19)

The analysis apparatus according to Supplementary note 18, wherein

the output means outputs the extracted attack path as the assessment result of the environmental metrics.

### (Supplementary Note 20)

The analysis apparatus according to Supplementary note 18 or 19, wherein

the output means outputs, as the assessment result of the base metrics, the CVSS base value information of the vulnerability in which an association with the base value countermeasure determination condition is shown.

### (Supplementary Note 21)

The analysis apparatus according to Supplementary note 20, wherein

the output means outputs, as the assessment result of the base metrics, a checklist indicating points to be checked for the vulnerability in the information system.

### (Supplementary Note 22)

An analysis method comprising:

assessing environmental metrics of a CVSS as regards a vulnerability in an information system based on an attack path extracted from the information system to which the vulnerability to be analyzed is applied;

assessing base metrics of the CVSS as regards the vulnerability in the information system based on obtained CVSS base value information of the vulnerability and a predetermined base value countermeasure determination condition of the information system; and

determining whether or not the vulnerability in the information system needs to be addressed based on an assessment result of the environmental metrics and an assessment result of the base metrics.

### (Supplementary Note 23)

The analysis method according to Supplementary note 22, wherein

it is determined whether or not the vulnerability in the information system needs to be addressed as the assessment of the environmental metrics.

### (Supplementary Note 24)

An analysis program for causing a computer to execute processing of:

assessing environmental metrics of a CVSS as regards a vulnerability in an information system based on an attack path extracted from the information system to which the vulnerability to be analyzed is applied;

assessing base metrics of the CVSS as regards the vulnerability in the information system based on obtained CVSS base value information of the vulnerability and a predetermined base value countermeasure determination condition of the information system; and

determining whether or not the vulnerability in the information system needs to be addressed based on an assessment result of the environmental metrics and an assessment result of the base metrics.

### (Supplementary Note 25)

The analysis program according to Supplementary note 24, wherein

it is determined whether or not the vulnerability in the information system needs to be addressed as the assessment of the environmental metrics.

### REFERENCE SIGNS LIST

1 ANALYSIS SYSTEM
10 ANALYSIS APPARATUS
11 ENVIRONMENT ASSESSMENT UNIT
12 BASE ASSESSMENT UNIT
13 DETERMINATION UNIT
20 COMPUTER
21 PROCESSOR
22 MEMORY
100 DETERMINATION APPARATUS
110 SECURITY INFORMATION COLLECTION UNIT
120 TEMPORAL VALUE DETERMINATION UNIT
121 COUNTERMEASURE DETERMINATION TABLE STORAGE UNIT
122 TEMPORAL VALUE OBTAINING UNIT
123 TEMPORAL VALUE COUNTERMEASURE DETERMINATION UNIT
130 ENVIRONMENTAL VALUE DETERMINATION UNIT
131 ANALYSIS ELEMENT SETTING UNIT
132 ATTACK PATH ANALYSIS UNIT
133 ATTACK PATH EXTRACTION UNIT
134 ENVIRONMENTAL VALUE COUNTERMEASURE DETERMINATION UNIT
140 BASE VALUE DETERMINATION UNIT
141 POLICY DETERMINATION TABLE STORAGE UNIT
142 BASE VALUE OBTAINING UNIT
143 BASE VALUE COUNTERMEASURE DETERMINATION UNIT
150 OUTPUT UNIT
200 SYSTEM CONFIGURATION INFORMATION DB
300 VULNERABILITY INFORMATION DB
400 INFORMATION SYSTEM
401 INTERNET
410 INFORMATION NETWORK
411 OA TERMINAL
420 CONTROL NETWORK
421 LOG SERVER
422 MAINTENANCE SERVER
423 MONITORING CONTROL SERVER
424 HMI
430 FIELD NETWORK
431 IoT DEVICE
432 FA DEVICE
501 DISPLAY SCREEN
501a SYSTEM INFORMATION DISPLAY AREA
501b ATTACK PATH INFORMATION DISPLAY AREA
501c REFERENCE INFORMATION DISPLAY AREA
FW1, FW2 FIREWALL
PLC1, PLC2 PROGRAMMABLE LOGIC CONTROLLER

What is claimed is:

1. An analysis apparatus comprising:
a memory storing instructions, and
a processor configured to execute the instructions stored in the memory to;
assess environmental metrics of a Common Vulnerability Scoring System (CVSS) as regards a vulnerability in an information system based on an attack path extracted from the information system to which the vulnerability to be analyzed is applied;
assess base metrics of the CVSS as regards the vulnerability in the information system based on obtained CVSS base value information of the vulnerability and a predetermined base value countermeasure determination condition of the information system; and
determine whether or not the vulnerability in the information system needs to be addressed based on an assessment result of the environmental metrics and an assessment result of the base metrics.

2. The analysis apparatus according to claim 1, wherein
the processor is further configured to execute the instructions stored in the memory to determine whether or not the vulnerability in the information system needs to be addressed as the assessment of the environmental metrics.

3. The analysis apparatus according to claim 2, wherein
the processor is further configured to execute the instructions stored in the memory to generate an attack graph based on the information system to which the vulnerability is applied, and extract an attack path from the generated attack graph.

4. The analysis apparatus according to claim 3, wherein
the processor is further configured to execute the instructions stored in the memory to determine that the vulnerability needs to be addressed when the attack path can be extracted from the attack graph.

5. The analysis apparatus according claim 2, wherein
the processor is further configured to execute the instructions stored in the memory to extract the attack path according to presence or absence of an important asset including the vulnerability in the information system and presence or absence of an external connection to the important asset.

6. The analysis apparatus according to claim 5, wherein
the processor is further configured to execute the instructions stored in the memory to extract the attack path when there is no important asset including the vulnerability in the information system or when there is no external connection to the important asset.

7. The analysis apparatus according to claim 5, wherein
the processor is further configured to execute the instructions stored in the memory to determine that the vulnerability needs to be addressed when there is the important asset including the vulnerability in the information system and there is the external connection to the important asset.

8. The analysis apparatus according to claim 1, the processor is further configured to execute the instructions stored in the memory to:
assess temporal metrics of the CVSS as regards the vulnerability in the information system based on obtained CVSS temporal value information of the vulnerability and a predetermined temporal value countermeasure determination condition of the information system; and
determine whether or not the vulnerability in the information system needs to be addressed based on the assessment result of the environmental metrics, the assessment result of the base metrics, and an assessment result of the temporal metrics.

9. The analysis apparatus according to claim 8, wherein
the processor is further configured to execute the instructions stored in the memory to determine whether or not the vulnerability in the information system needs to be addressed as the assessment of the temporal metrics.

10. The analysis apparatus according to claim 9, wherein
the temporal value countermeasure determination condition is a condition that associates a temporal value calculation element of the CVSS temporal value information with whether or not the vulnerability in the information system needs to be addressed.

11. The analysis apparatus according to claim 10, wherein
the temporal value calculation element includes presence or absence of an attack method, presence or absence of an attack case, or presence or absence of a mitigation measure.

12. The analysis apparatus according to claim 11, wherein
the processor is further configured to execute the instructions stored in the memory to, when there are the attack case of the CVSS temporal value information and the mitigation measure of the CVSS temporal value information, determine that the vulnerability needs to be addressed.

13. The analysis apparatus according to claim 1, wherein
the processor is further configured to execute the instructions stored in the memory to determine whether or not the vulnerability in the information system needs to be addressed as the assessment of the base metrics.

14. The analysis apparatus according to claim 13, wherein
the base value countermeasure determination condition is a condition in which a system characteristic in the information system is associated with each base value calculation element of the CVSS base value information.

15. The analysis apparatus according to claim 14, wherein
the processor is further configured to execute the instructions stored in the memory to, when information about the base value calculation element of the CVSS base value information corresponds to the system characteristic of the base value countermeasure determination condition, determine that the vulnerability needs to be addressed.

16. The analysis apparatus according to claim 14, wherein
the base value calculation element includes complexity of an attack condition, a privilege level, or user interaction.

17. The analysis apparatus according to claim 14, wherein
the base value countermeasure determination condition further includes presence or absence of measure information and presence or absence of an attack detection method.

18. The analysis apparatus according to claim 1, wherein
the processor is further configured to execute the instructions stored in the memory to output the assessment result of the environmental metrics and the assessment result of the base metrics according to a result of determining whether or not the vulnerability needs to be addressed.

19. The analysis apparatus according to claim 18, wherein
the processor is further configured to execute the instructions stored in the memory to output the extracted attack path as the assessment result of the environmental metrics.

20. The analysis apparatus according to claim 18, wherein
the processor is further configured to execute the instructions stored in the memory to output, as the assessment result of the base metrics, the CVSS base value information of the vulnerability in which an association with the base value countermeasure determination condition is shown.

21. The analysis apparatus according to claim 20, wherein
the processor is further configured to execute the instructions stored in the memory to output, as the assessment result of the base metrics, a checklist indicating points to be checked for the vulnerability in the information system.

22. An analysis method comprising:
assessing environmental metrics of a CVSS as regards a vulnerability in an information system based on an attack path extracted from the information system to which the vulnerability to be analyzed is applied;
assessing base metrics of the CVSS as regards the vulnerability in the information system based on obtained CVSS base value information of the vulnerability and a predetermined base value countermeasure determination condition of the information system; and
determining whether or not the vulnerability in the information system needs to be addressed based on an assessment result of the environmental metrics and an assessment result of the base metrics.

23. The analysis method according to claim 22, wherein
it is determined whether or not the vulnerability in the information system needs to be addressed as the assessment of the environmental metrics.

24. A non-transitory computer readable medium storing an analysis program for causing a computer to execute processing of:
assessing environmental metrics of a CVSS as regards a vulnerability in an information system based on an attack path extracted from the information system to which the vulnerability to be analyzed is applied;
assessing base metrics of the CVSS as regards the vulnerability in the information system based on obtained CVSS base value information of the vulnerability and a predetermined base value countermeasure determination condition of the information system; and
determining whether or not the vulnerability in the information system needs to be addressed based on an assessment result of the environmental metrics and an assessment result of the base metrics.

25. The non-transitory computer readable medium according to claim 24, wherein
it is determined whether or not the vulnerability in the information system needs to be addressed as the assessment of the environmental metrics.
